(19) United States
(12) Patent Application Publication
(10) Pub. No.: US 2002/0067389 A1
(43) Pub. Date: Jun. 6, 2002

(54) Method for the formation of coloured pixels and print head and inkjet printing device for application of the method

(76) Inventors: Robert E.A. Braun, Uden (NL); Petrus L.J. Welten, Boxmeer (NL); Jan J. Boomgaardt, Boxmeer (NL); Fulgencio Arjona-Gomez, Eindhoven (NL)

Correspondence Address: Todd Deveau, Troutman Sanders LLP, 600 Peachtree St., Suite 5200, Atlanta, GA, 30308-2216, US

(21) Appl. No.: 10/044,429

(22) Filed: Jan. 11, 2002

Related U.S. Application Data
(63) Continuation-in-part of application No. PCT/NL00/00484, filed on Jul. 10, 2000.

(30) Foreign Application Priority Data
Jul. 16, 1999 (NL) 1012624

(51) Int. Cl. B41J 23/00

(52) U.S. Cl. 347/37

(57) ABSTRACT

For the formation of colored pixels on a substrate, a print head can be used which performs a forward and return movement in relation to the substrate and which has a number of ink nozzles, in which the different ink nozzles can produce ink droplets of different colors. A print head which, in the direction of the first movement, comprises at least two parallel rows of at least two ink nozzles can be used. Preceding the printing step the printing method comprises the step of entailing the allocation in each case of two neighboring colors in a color space to ink nozzles of different rows, and black either to one or more ink nozzles of a separate row or to the first ink nozzle and last ink nozzle of the same row.

### CROSS-REFERENCE TO RELATED APPLICATION

This is a continuation application of PCT/NL00/00484 filed Jul. 10, 2000, which PCT application claims priority of Dutch patent application number 1012624 filed Jul. 16, 1999, herein incorporated by reference.

### FIELD OF THE INVENTION

The invention relates to the formation of coloured pixels for example with a colour printing device, such as a colour inkjet printer. More specifically, the invention relates to a method for the printing of colour images with the aid of a printing device with a print head according to the preamble to claim 1.

A method of this type is known in practice.

### BACKGROUND OF THE INVENTION

In colour printing devices, only a limited number of different ink colours is necessarily available. However, in order to be able to print pixels with any given pixel colour, ink droplets of different colours are combined in a pixel. Through a suitable choice of the ink colours used and the numbers of ink droplets for each pixel, virtually all pixel colours can be obtained. In general, the primary colours cyan (C), magenta (M) and yellow (Y) are used, usually supplemented by black (K). These four colours are also referred to as basic colours. Additional colours may also be used along with these basic colours. The term “process colours” is used to indicate all the colours which are actually used in a printing device.

In colour printing devices of which the print head performs a forward and return movement in relation to a substrate, and in which the ink nozzles are aligned in a row behind one another, the problem occurs that the sequence in which ink droplets of different colours produce a pixel is dependent on the direction of movement of the print head. If a pixel colour is composed, for example, from the basic colours yellow and magenta, in which yellow is located in the print head to the right of magenta, if the print head moves from left to right, first a yellow and then a magenta ink droplet will be applied to a pixel. As a result, the magenta ink droplet will lie on the yellow ink droplet. In the opposite direction of movement, first magenta and then yellow will be applied, so that the yellow ink droplet will lie on the magenta ink droplet.

It has appeared that reversal of the deposition sequence of the composing ink droplets can cause colour differences. Particularly if, in one movement, a plurality of consecutive image lines (rows of pixels) are formed, this colour difference may be evident in the form of “tracks” in the image. It will be clear that this is undesirable.

It is of course possible to solve this problem by arranging the different ink nozzles in the print head, seen in the direction of movement of the print head, underneath rather than behind each other. However, this has the disadvantage that a pixel is formed in many successive passes, while deformation (e.g. shrinkage) of the substrate may occur between the passes. This causes register problems, which can only be solved through sophisticated and costly additional measures.

The invention is intended to eliminate the aforementioned and other disadvantages of the state of the art and to produce a method for the formation with a print head on a substrate of pixels with a predefined pixel colour, which method prevents the occurrence of colour tracks in the image, and in which method the aforementioned register problems of the state of the art are minimized as far as possible.

### SUMMARY OF THE INVENTION

In a method according to the invention a print head is used which, in the direction of the first movement, comprises at least two parallel rows of at least two ink nozzles, wherein the method preceding the printing step comprises the step entailing the allocation in each case of neighbouring colours in the colour space to ink nozzles of the different rows of ink nozzles, where black is allocated either to one or more ink nozzles of a separate row of ink nozzles or to the first and last ink nozzle of the same row of ink nozzles.

The invention is based on the insight that any given pixel colour in the colour space, composed of the ink colours used, can be made up of three process colours, including black. Normally, the two process colours lying closest to the given pixel colour and black are used. This can be defined, for example, from a colour space in which black lies at least approximately in the middle, and in which the colour intervals are measured using the coordinates of the colours according to the CIELAB standard. Process colours which have the shortest interval between them in the colour space are herein referred to as neighbouring colours. According to the invention, these neighbouring colours are allocated to ink nozzles in different rows, whereas the colour black, according to a first option, is allocated to one or more ink nozzles of a separate row, so that the print head comprises at least three rows. As a second option, the colour black is allocated to the ink nozzles at both ends of a row, which row will likewise comprise ink nozzles for other colours.

By applying the ink droplets in successive movements (one movement is the forward or return movement, i.e. one pass comprises two movements) of the print head on the substrate, register problems are avoided as far as possible, given that the time between the successive movements can be very short.

By allocating the ink colours in advance to the ink nozzles, as defined above, the pixel colours can be composed from combinations of ink colours which, in each case irrespective of the direction of movement of the print head in relation to the substrate, are applied in the same sequence and therefore cause no colour differences. One row preferably consists entirely of ink nozzles for the colour black.

By dividing neighbouring colours, i.e. the colours which lie closest to each other in the colour space, in each case into different rows, a maximum number of colours can be printed without colour differences dependent on the direction of movement.

### BRIEF DESCRIPTION OF THE DRAWINGS

The invention will be explained in more detail below with reference to the drawing, in which:

FIG. 1 is a schematic diagram showing a substrate to which pixels are applied;

FIG. 2 is a schematic diagram showing a colour space with a number of basic colours and some additional colours;

FIG. 3 is a schematic diagram showing a first print head according to the state of the art;

FIG. 4 is a schematic diagram showing a second print head according to the state of the art;

FIG. 5 is a schematic diagram showing a first embodiment of a print head according to the invention;

FIG. 6 is a schematic diagram showing a second embodiment of a print head according to the invention; and

FIG. 7 is a schematic diagram showing a third embodiment of a print head according to the invention.

### DESCRIPTION OF THE PREFERRED EMBODIMENTS

The colours cyan, magenta, yellow, black and at least one additional colour are advantageously used. More preferably, the colours yellow (Y), a first additional colour and a second additional colour are allocated to a first row, and the colours magenta (M), cyan (C) and a third additional colour are allocated to a second row. Even more preferably, in a colour space, the first additional colour lies between cyan (C) and magenta (M), and the second and third additional colours lie between magenta (M) and yellow (Y). These additional colours may, for example, be selected from blue, red, golden yellow and orange.

The invention furthermore provides a print head according to claim 5. This enables the formation of pixels always from combinations of neighbouring colours which are such that an ink colour from the first row and an ink colour from the second row are used. As a result, the sequence of ink droplets applied to the substrate is again independent of the direction of movement of the print head.

The invention furthermore produces an inkjet printing device which is fitted with a print head of this type.

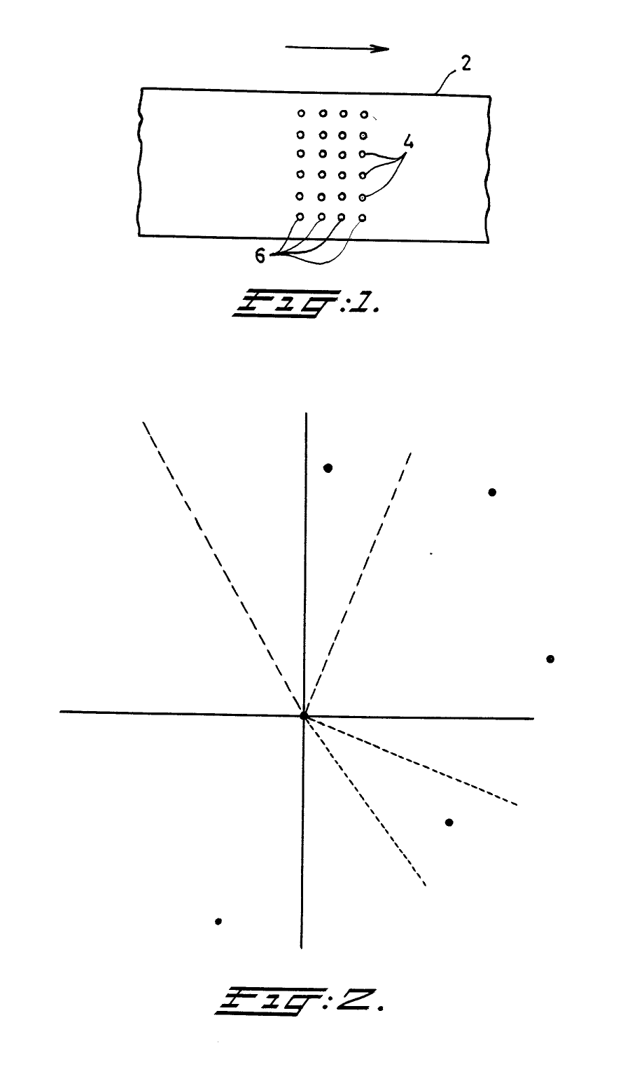

The substrate 2 shown in FIG. 1 may be made from textile, paper and the like. Pixels 4 are applied to the substrate 2 with the aid of a printing device (not shown). The pixels 4 form image lines 6. During operation, a print head (not shown) of the printing device performs, in successive passes, a forward and return first movement in relation to the substrate 2. During each pass, ink droplets are deposited on the substrate 2, as a result of which the pixels 4 of an image line 6 are in each case formed. After each pass, the print head performs a second movement in relation to the substrate 2, which movement, for example, may be performed by transporting the substrate 2, as indicated by an arrow. Normally, the first and second movement are at right angles to each other, so that an image line to be applied in the following pass, comprising pixels by means of droplet deposition, will be applied parallel with the preceding, already printed, image line. A printing device as described above is known as a bidirectional intermittent printer.

FIG. 2 shows an example of a colour space which is composed of the basic colours yellow (Y), cyan (C), magenta (M) and black (K), and also 4 additional colours (indicated here as G, H, I, and J), which together produce 8 process colours. In this case, the additional colours G, H and I lie between yellow (Y) and magenta (M) and J lies between cyan (C) and magenta (M). The choice of additional colours is not critical, but is partly determined by commercial requirements.

A pixel with pixel colour X₁ can be formed from the colour combination Y, G and K, and a pixel with pixel colour X₂ can be formed from the colours M, J and K. If a pixel colour X₁ of this type is to be printed with a print head 10 according to the state of the art, in which the ink nozzles 12 with different colours are positioned behind one another, as shown in FIG. 3, in the forward movement (indicated with an arrow), first the correct number of ink droplets with ink colour G will be applied to a pixel, followed by one or more ink droplets with the colour K and then Y. Seen from the substrate, the pixel colour is then composed from the colour sequence GKY. If the same picture element colour needs to be printed in the return movement of the print head, first ink droplets with the ink colour Y, then black ink droplets, and finally ink droplets with the ink colour G are deposited on the picture element, i.e. a colour sequence YKG. It has appeared that a different deposition sequence, as illustrated above, can produce a different colour, which may result in the formation of visible tracks with different colours, which is of course undesirable.

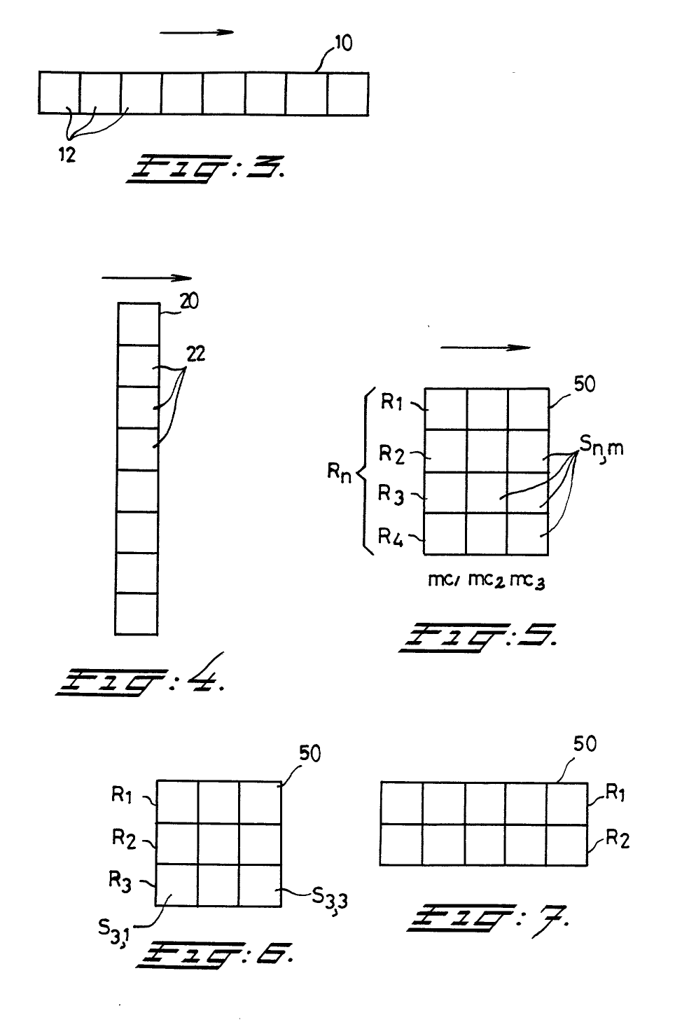

FIG. 4 shows a second print head 20 according to the state of the art, in which the nozzle openings 22 are positioned under each other. Although the problem of the formation of tracks as a result of differing droplet deposition in the forward and return movement can be avoided with a print head 20 of this type, since in the embodiment shown the sequence will always be identical (either YKG or GKY, depending on the direction of movement of the substrate), a relatively large number of passes are required for printing, so that the total time required to compose a pixel colour may be considerably long, and, between the deposition of ink droplets with different colours on the same pixel, shrinkage of the substrate may occur, which may result in register faults. For example, to compose the pixel colour X₂, composed of M, J and K, and given the print head according to FIG. 4, six movements are required.

FIG. 5 shows a first embodiment of a print head 50 according to the invention. The print head 50 comprises four rows Rₙ, with n=1-4, of ink nozzles S_{n,m}, in which n indicates the row (=1-4) and m the number of the ink nozzle (m=1-3), to which 8 process colours are allocated in accordance with the method according to the invention. Yellow (Y) is allocated to the first ink nozzle S_{1,1} in row R₁. Cyan (C), which is a neighbouring colour of yellow (Y), given this colour set, may, according to invention, not be present in the first row R₁, and, in this example, is allocated to the second ink nozzle S_{2,2} of the second row R₂. The additional colour J, which is not a neighbouring colour of yellow (Y), may then be allocated to an ink nozzle of the first row R₁, for example S_{1,2}, in the same way as I (to S_{1,3}), whereas the colours M and H are allocated to ink nozzles S_{2,1} and S_{2,3} respectively of the second row R₂. The additional colour G, which is a neighbouring colour of both Y, which occurs in the first row R₁, and H, which is present in the second row R₂, is allocated to an ink nozzle of a third row R₃ and the colour black (K) is allocated to one or more ink nozzles of the fourth row R₄.

If the pixel colours X₁ and X₂ (see FIG. 2) are to be printed with the print head 50, these are formed, regardless of the direction of movement of the print head, by successive droplet deposition of the colours Y, G and K, and J, M and K respectively. Formation of colour tracks is thus avoided and register problems are minimized as far as possible.

In the embodiment of a print head shown in FIG. 5, only one colour is allocated to the ink nozzles S_{3,m} and S_{4,m} of the third row and fourth row R₃ and R₄. In a further modification according to FIG. 6, the colour black is allocated to both the first ink nozzle S_{3,1} and the last ink nozzle S_{3,3} of the third row R₃, so that the last row R₄ can be eliminated, whereas the pixel colour X₁ can be printed without colour differences, regardless of the direction of movement. Indeed, during the forward pass, for example, the colour sequence YGK can be printed with K from the ink nozzle S_{3,1}, and, in the return pass, YGK can likewise be printed with K from the ink nozzle S_{3,3}.

A further modification of the print head may entail elimination of the colour G, because this, for example, in practice gives a smaller increase in the colour range than the additional colour H. In this case, if required and if sufficient ink nozzles S are present in a row R, the colour K could also be allocated to the first and last ink nozzles of any given row, as shown in FIG. 7.

In the method and print head according to invention, in particular the print head with a configuration as shown in FIG. 7, the occurrence of tracks with colour differences as a result of a different droplet deposition sequence (FIG. 3) is totally eliminated, whereas register problems, such as those which occur in a print head according to FIG. 4, are minimized.

It will be understood that the position of the rows may be transposed, for example transposition of the rows R₂ and R₃ in the print head according to FIG. 6 produces the same solution.

What is claimed is:

1. Method for the printing of colour images with the aid of a printing device with a print head on a substrate, which print head (50) is set up to perform a forward and return first movement in relation to the substrate and to perform a second movement in relation to the substrate, which movements essentially run at right angles and parallel with the substrate, and which print head comprises a number of ink nozzles to form ink droplets with an ink colour, including black, associated with the relevant ink nozzle, which method comprises a printing step involving the formation from ink droplets with different ink colours, on the substrate of a pixel with a predefined pixel colour during the performance of the aforementioned first movement, wherein a print head is used which, in the direction of the first movement, comprises at least two parallel rows of at least two ink nozzles, in which the method preceding the printing step comprises the step entailing the allocation in each case of two neighbouring colours in a colour space to ink nozzles of different rows, and black either to one or more ink nozzles of a separate row or to the first and last ink nozzle of the same row.

2. Method according to claim 1, wherein the colours cyan, magenta, yellow, black and at least one additional colour are used.

3. Method according to claim 2, wherein the colours yellow, a first additional colour and a second additional colour are allocated to the ink nozzles of the first row, and the colours magenta, cyan and a third additional colour are allocated to the ink nozzles of a second row.

4. Method according to claim 3, wherein in a colour space, the first additional colour lies between cyan and magenta, and the second and third additional colours lie between magenta and yellow.

5. Print head for a colour inkjet printing device, comprising at least two parallel rows of at least two ink nozzles for the formation of ink droplets with an ink colour associated with the relevant ink nozzle, wherein, for all ink colours, two neighbouring colours in a colour space have been allocated to ink nozzles of different rows, and black has been allocated either to one or more ink nozzles of a separate row or to the first ink nozzle and last ink nozzle of the same row.

6. Colour inkjet printing device provided with a print head comprising at least two parallel rows of at least two ink nozzles for the formation of ink droplets with an ink colour associated with the relevant ink nozzle, wherein, for all ink colours, two neighbouring colours in a colour space have been allocated to ink nozzles of different rows, and black has been allocated either to one or more ink nozzles of a separate row or to the first ink nozzle and last ink nozzle of the same row.
